(19) United States
(12) Patent Application Publication
(10) Pub. No.: US 2008/0198418 A1
(43) Pub. Date: Aug. 21, 2008

(54) Image forming apparatus

(75) Inventor: Tohru Nagatsuma, Kanagawa (JP)

Correspondence Address: HARNESS, DICKEY & PIERCE, P.L.C., P.O. BOX 8910, RESTON, VA, 20195, US

(73) Assignee: RICOH COMPANY, LITMITED

(21) Appl. No.: 11/896,547

(22) Filed: Sep. 4, 2007

(30) Foreign Application Priority Data
Sep. 19, 2006 (JP) 2006-253234

(51) Int. Cl. H04N 1/48

(52) U.S. Cl. 358/2.1; 358/1.2

(57) ABSTRACT

An image forming apparatus that facilitates combination of a monochromatic scanner or a color scanner with a monochromatic plotter includes a common image-processing unit for a monochrome and a color that processes monochromatic image data and color image data that is input via an interface from an exclusive reader for a color scanner or a monochromatic scanner. If the monochrome reader is connected, the image-processing unit processes the monochromatic image data and if the color reader is connected, the image-processing unit processes the color image data.

### CROSS-REFERENCE TO RELATED APPLICATIONS

The present application claims priority to and incorporates by reference the entire contents of Japanese priority document, 2006-253234 filed in Japan on Sep. 19, 2006.

### BACKGROUND OF THE INVENTION

1. Field of the Invention

The present invention relates to an image forming apparatus of a digital system that includes a scanner and a plotter, implements a plurality of functions such as a copying function, a printing function, a scanning function, and a facsimile (FAX) function, and that facilitates a combination of a monochromatic scanner or a color scanner with respect to a monochromatic plotter.

2. Description of the Related Art

In a commonly used image forming apparatus that includes a printing and a copying function, a controller that includes an application-specific integrated circuit (ASIC) or a central processing unit (CPU) for an image processing is connected to an engine. An image forming processing is mostly carried out using the controller. For example, in the copying function, the ASIC that includes hardware elements for a plurality of image processings is installed in the controller and the ASIC and the engine are connected by a peripheral component interconnect (PCI) interface. Furthermore, the CPU and the ASIC that are fixedly set up in the same controller are connected and a copy processing is carried out under the control of the CPU. While creating a new image forming apparatus of a high performance, the controller that processes images and exercises control needs to be replaced for each unit by a high-speed controller.

A technology related to a replacement by the high performance unit is disclosed in Japanese Patent No. 3682443.

However, in addition to the image forming apparatus of the high performance, a problem arises in a demand ratio for a color function and a monochromatic function. In a digital multifunction product, even if the demand for the color function is increasing, a total ratio for the monochromatic function is more than or equal to 80%. Particularly the demand in overseas countries is more. When developing a digital multifunction product, only the scanner can be considered for the color according to requirements of a user. In other words, a monochrome can be considered for the copying function and a color can be considered for the scanning function. In such digital multifunction product, a monochromatic structure version and a color structure version need to be created and handled separately. Especially, in the overseas countries where the demand for the monochromatic function is high, there is a strong requirement for creating the separate monochromatic scanner structure version and the color scanner structure version in one digital multifunction product.

However, predicting the ratio of the requirements of the monochromatic scanner structure version machine and the color scanner structure version machine is difficult. Upon producing the machine of each version mentioned earlier at a production site, when finished products of the separate version are shipped, a stock of the machines including the version that is less in demand, is likely to be accumulated in a storehouse in the overseas countries. Thus, if only a required quantity of a plotter, the monochromatic scanner, and the color scanner that are the base (as the machine in a semi-finished product status) is shipped from the production site and according to the requirements of the user, the machine of the monochromatic scanner structure or the color scanner structure is assembled without any efforts at a consumption site in the overseas countries, accumulation of the machine stock can be avoided.

If the versions are created by including an image-processing unit (IPU) that is the core of a scanner image processing, it is necessary to develop a new controller software or to make a significant change in resource. The new development or the significant change in the resource involves a risk or a large development time, thereby not enabling to timely dispatch the product in the world. Further, the efforts required at the consumption site for creations are greater than the creations made including IPU, which is not acceptable in the production.

For an interface between the IPU in the color scanner and the monochromatic scanner, because there is a difference that is optimized with respect to each characteristic and a cost, if a common IPU is used, a unit is required that absorbs the difference. Further, because the cost of the monochromatic structure machine needs to be significantly reduced, even if the common IPU is used, a cost needs to be optimized with respect to the machine of the monochromatic structure.

### SUMMARY OF THE INVENTION

It is an object of the present invention to at least partially solve the problems in the conventional technology.

According to an aspect of the present invention, there is provided an image forming apparatus that facilitates combination of a monochromatic scanner or a color scanner with a monochromatic plotter. The image forming apparatus includes a common image-processing unit for a monochrome and a color that processes monochromatic image data and color image data that is entered, via an interface, from an exclusive reader for the monochromatic scanner and the exclusive reader for the color scanner. The image-processing unit processes the monochromatic image data when the monochrome reader is connected, and processes the color image data when the color reader is connected.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic for explaining a background of the present invention;

FIG. 2 is a block diagram of a circuit configuration according to a first embodiment of the present invention in which a color scanner and a plotter are combined;

FIG. 3 is a block diagram of a circuit configuration according to a second embodiment of the present invention in which a monochromatic scanner and the plotter are combined;

FIG. 4 is a block diagram of relevant parts of a monochromatic SIU;

FIG. 5 is a time chart indicating output timings of signals within the monochromatic SIU B that is shown in FIG. 4;

FIG. 6 is a flowchart of a process that determines whether a current connection status indicates a color structure or a monochromatic structure;

FIG. 7 is a block diagram of a circuit configuration of the digital multifunction product according to a third embodiment of the present invention; and

FIG. 8 is a block diagram of a circuit configuration of the digital multifunction product according to a fourth embodiment of the present invention.

### DETAILED DESCRIPTION OF THE PREFERRED EMBODIMENTS

Exemplary embodiments of the present invention are explained in detail below with reference to the accompanying drawings.

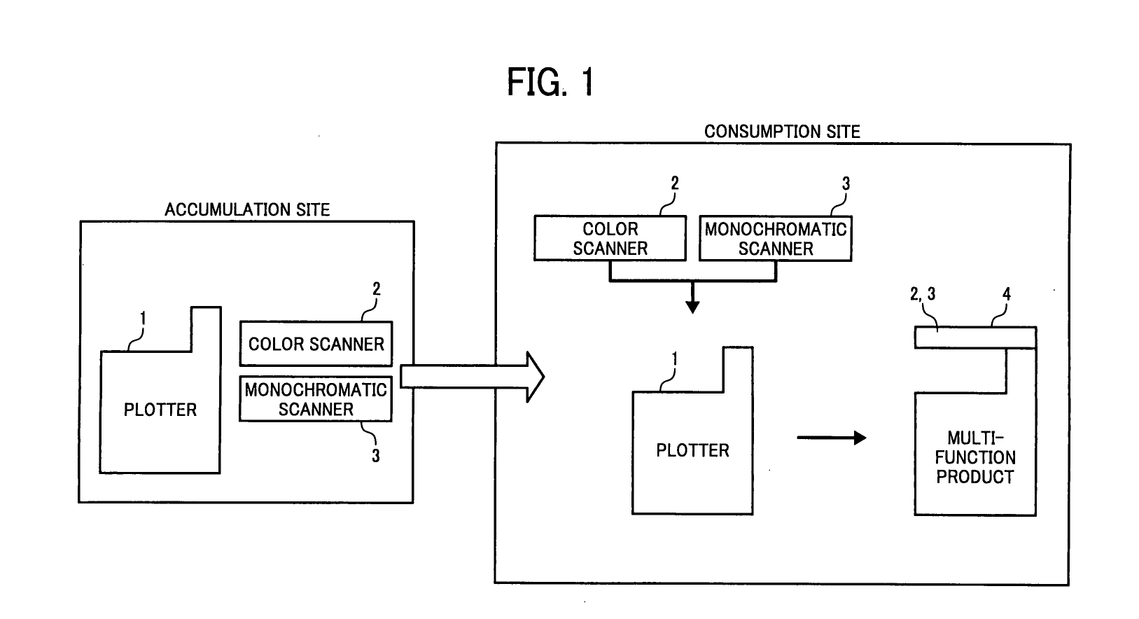

FIG. 1 is a schematic for explaining a background of the present invention. When exporting to or selling in overseas countries, a digital multifunction product in which various functions can be combined, units of various structures are shipped in unassembled status from a production or an accumulation site and are combined at a consumption site to create a finished product of a required function structure. FIG. 1 is an example of the digital multifunction product that facilitates voluntary combination of a monochromatic scanner or a color scanner with respect to a plotter of a monochromatic output.

In the accumulation site, a plotter 1, a color scanner 2, and a monochromatic scanner 3 that are to be shipped are available as individual units. After shipping the units from the accumulation site to the consumption site, at the consumption site the plotter 1 is assembled with the color scanner 2 or the monochromatic scanner 3 depending upon the requirements to accomplish a digital multifunction product 4.

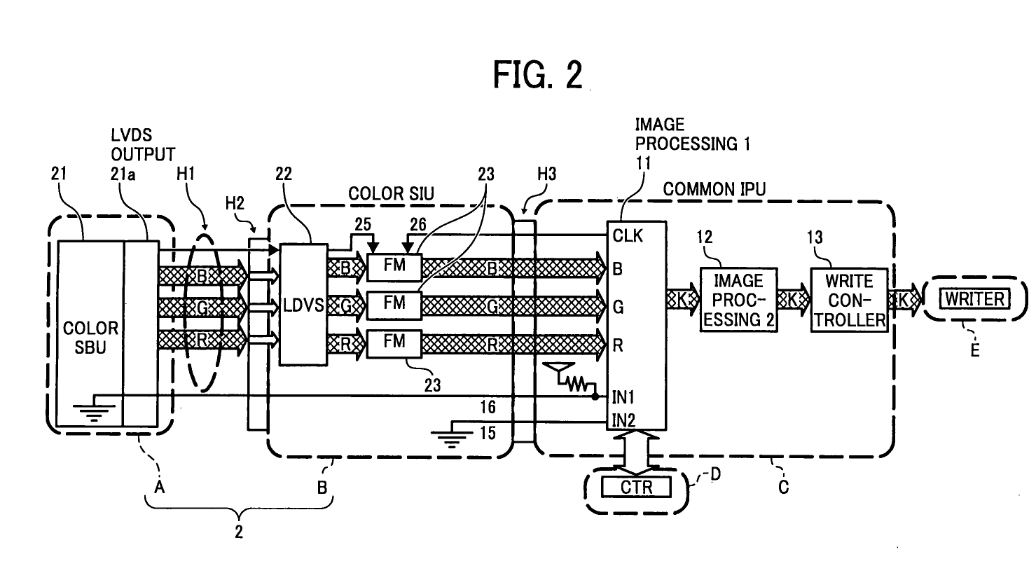

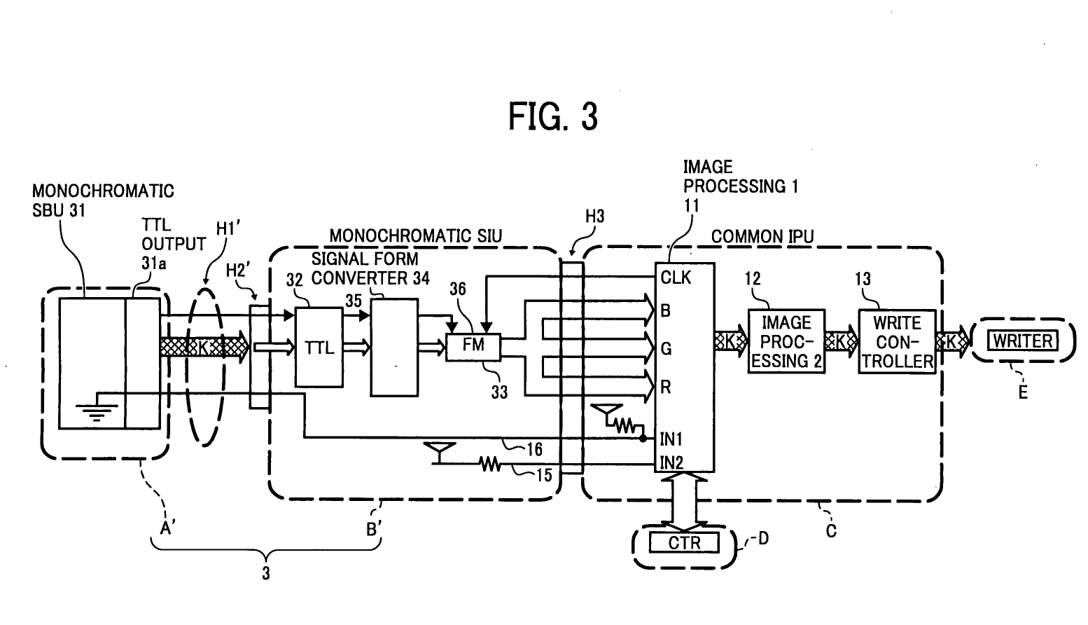

FIG. 2 is a block diagram of a circuit configuration when the color scanner 2 is combined with the plotter 1. FIG. 3 is a block diagram of a circuit configuration when the monochromatic scanner 3 is combined with the plotter 1.

As shown in FIG. 2, the color scanner 2 includes a color reader (hereinafter, “color scanner”) A and a color scanner interface unit (hereinafter, “color SIU”) B. The color scanner A is installed in the color scanner 2 before shipment is carried out from the accumulation site.

The color SIU B is installed in the plotter 1 when the color scanner 2 is assembled with the plotter 1 at the consumption site. A symbol C represents a common image-processing unit (hereinafter, “IPU”), a symbol D represents a controller, and a symbol E represents a writer. The IPU C is already installed in the plotter 1 before shipment is carried out from the accumulation site.

On the other hand, as shown in FIG. 3, the monochromatic scanner 3 includes a monochrome reader (hereinafter, “monochromatic scanner”) A′ and a monochromatic scanner interface unit (hereinafter, “monochromatic SIU”) B′. The monochromatic scanner A′ is already installed in the monochromatic scanner 3 before the shipment is carried out from the accumulation site. The monochromatic SIU B′ is installed in the plotter 1 when the monochromatic scanner 3 is assembled with the plotter 1 at the consumption site. Similar to the circuit configuration shown in FIG. 2, the color scanner 2, the IPU C, the controller D, and the writer E are also provided in the circuit configuration shown in FIG. 3. The IPU C, the controller D, and the writer E are common in the monochromatic function and the color function and the controller D and the writer E are already installed in the plotter 1. In other words, in the first and second embodiments, while assembling the color scanner 2 or the monochromatic scanner 3 with the plotter 1 at the consumption site, the color SIU B or the monochromatic SIU B′ conforming to each unit is fitted within the plotter 1.

The color scanner A includes a color reader (hereinafter, “color SBU”) 21 and a low-voltage differential signaling (LVDS) interface 21a and with respect to a read color image, delivers to the color SIU B, image data signals of three types such as R, G, B through an LVDS output. The LVDS interface is adopted in a color image signal interface due to the following reasons. A number of signal lines can be reduced for transferring each signal cluster (10 bits) of R, G, B by parallel to serial conversion, a high-speed transfer is enabled, the LVDS interface is strong for an exogenous noise and deterioration of strong signals is very less, useful for an action on an electromagnetic interface (EMI) (unwanted radiations) that cannot generate a noise by itself.

The color SIU B includes an LVDS receiver 22 and a frame memory (shown as FM in a drawing) 23 provided for each R, G, B color. The LVDS receiver 22 receives from the color SBU 21 of the color scanner A, each serially transferred signal of R, G, B and converts into parallel data (each 10 bits). The frame memory 23 temporarily retrieves image data that is transferred from the color SBU 21 and absorbs the difference in a processing speed of a scanning-image processing unit 11 (shown as an image processing 1 in the drawing). A memory required for color data is an amount that is essential for three colors such as R, G, B.

The scanning-image processing unit 11 includes a function to be sent to the controller D by processing the image signals that are passed from the color SBU 21 as scanner signals and the function to be sent to a print image-processing unit 12 (shown as an image processing 2 in the drawing) by processing the image signals as print signals. The print image-processing unit 12 processes the image data transferred from the scanning-image processing unit 11 as printing data. The print image-processing unit 12 transfers the processed image data to a write controller 13. The write controller 13 converts printing image data that is processed in the print image-processing unit 12 into writing signals and includes the function for passing the writing signals to the writer E. The scanning-image processing unit 11 and the print image-processing unit 12 are structured by the respective ASIC in the first and second embodiments.

Because there is the difference in the processing speed of the scanning-image processing unit 11 and a data transfer speed of the color SBU 21, the difference is absorbed by temporarily accumulating the image data in the frame memory 23 and the image data with respect to the frame memory 23 is retrieved from the color SBU 21 in synchronization with a data transferring clock signal 25 that is delivered from the color SBU 21. The image data with respect to the scanning-image processing unit 11 is transferred from the frame memory 23 in synchronization with a data retrieval clock signal 26 that is delivered from the scanning-image processing unit 11.

However, in the circuit configuration for monochrome function that is shown in FIG. 3, the color SBU 21 in the color machine is replaced by a monochromatic SBU 31, the LVDS interface 21a is replaced by a transistor-transistor level (TTL) interface 31a, the LVDS 22 is replaced by a TTL 32, and the frame memory 23 of three colors is replaced by a unicolor frame memory 33. A signal form converter 34 is provided between the TTL 32 and the frame memory 33. The structure of the IPU C, the controller D, and the writer E is similar to the color machine that is shown in FIG. 2.

The monochromatic SBU 31 includes the TTL interface 31a and with respect to a read color copy, delivers to the monochromatic SIU B′, the image data signal of Black (K) type through a TTL output. The TTL interface is adopted in the monochromatic image data signals due to the following reasons. Because a TTL element that structures an interface is in affordable price and as compared to the color, because a number of signals is less (approximately ⅓) in monochrome, in a data transfer method, all bits can be transferred parallely and the data transfer speed is also within a permissible range.

Upon receiving K signals that are parallely passed from the monochromatic scanner A′, a receiver of the TTL 32 distributes the K signals to the signal form converter 34. The signal form converter 34 includes the function that converts the image signals data of all parallel bits that is transferred from the monochromatic SBU 31 into a data format that can be retrieved by the scanning-image processing unit 11. The frame memory 33 requires the memory of the amount that is essential for color K. Thus, the required capacity in the monochrome is ⅓ of the color.

In the color structure, all the data of R, G, B is transferred to a respective data entry box of R, G, B of the scanning-image processing unit 11 via the color SIU B. In the monochromatic structure, data after output from the frame memory 33 is connected to each data input box of R, G, B of the scanning-image processing unit 11 such that the data having the same contents can be entered at the same time in the monochromatic SIU B′.

The frame memory 23 of the color structure and the frame memory 33 of the monochromatic structure are installed in the SIU unit B and B′ respectively instead of installing in the common IPU C. A memory of a minimum capacity that is required for the monochromatic or the color structure is installed in the frame memory 23 and 33. Thus, especially in the monochromatic structure, the cost can be reduced.

In FIG. 2, a reference symbol Hi is a harness for connecting the color scanner A and the color SIU B. An exclusive connector H2 for the color SIU connects the harness H1 and the color SIU B. Furthermore, the color SIU B and the IPU C are connected by a board-to-board connector H3. The connector H3 is common in the color SIU B and the monochrome SIU B′.

In FIG. 3, a reference symbol H1′ is the harness for connecting the monochromatic scanner A′ and the monochromatic SIU B′. An exclusive connector H2′ for the monochromatic SIU connects the harness H1′ and the monochromatic SIU B′.

The harness H1 is used for connecting the color scanner A and the color SIU B and the harness H1′ is used for connecting the monochromatic scanner A′ and the monochromatic SIU B′, thereby enabling to flexibly position the color SIU B and the monochromatic SIU B′ in the plotter 1. Furthermore, the harness H1 and the color SIU B, the harness H1′ and the monochromatic SIU B′, the color SIU B and the IPU C, the monochromatic SIU B′ and the IPU C are connected by a respective board-to-board connector. Due to this, deterioration of the image signals can be prevented and an image signal circuit that includes the frame memory 23 and 33 can be installed in the color SIU B and the monochromatic SIU B′.

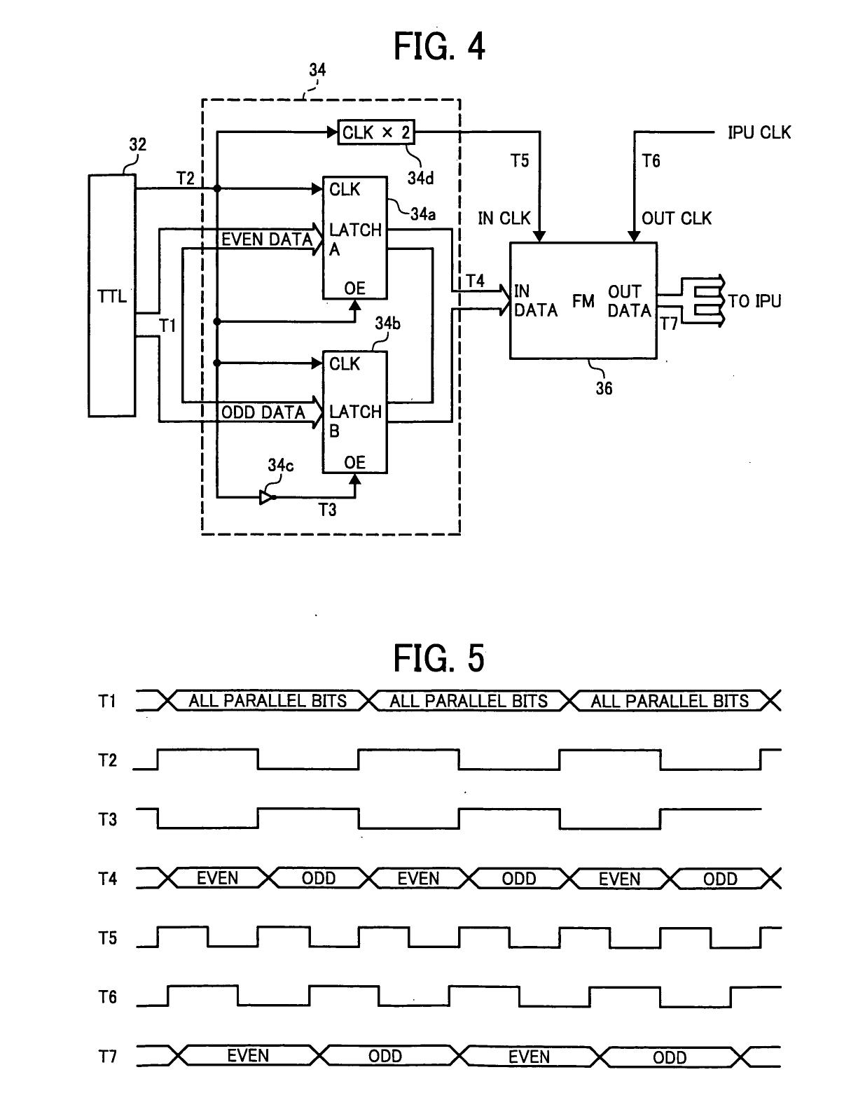

FIG. 4 is a block diagram of relevant parts of the monochromatic SIU B′. FIG. 5 is a time chart of output timings of the signals within the monochromatic SIU B′. In FIG. 4, a block that is surrounded by a dotted line indicates details of the relevant parts of the signal form converter 34. Furthermore, timings T1 to T7 shown in FIG. 5 correspond to the timings T1 to T7 shown in FIG. 4.

As shown in FIG. 4, the signal form converter 34 receives all parallel bits data (T1) from the monochromatic SBU 31 via the TTL 32. The data is usually 16-bit data. Moreover, the signal form converter 34 receives a data transfer clock T2 from the TTL 32. The data transfer clock T2 corresponds to a data transfer clock 35 that is shown in FIG. 3. The data transfer clock T2 is transmitted from the monochromatic SBU 31 and all parallel bits data (T1) is sent in synchronization with the data transfer clock T2 (35). In FIG. 5, T1 is all parallel bits data and is modified in synchronization with rising edge of T2.

As shown in FIG. 4, the signal form converter 34 includes a first latch circuit 34a and a second latch circuit 34b (shown as a LATCH A and a LATCH B in the drawing), an inverter 34c, and a frequency converting circuit 34d. From all parallel bits data T1, the first latch circuit 34a temporarily saves data of only even bits (usually, 8-bit) and only a data line of the even bit data is connected to an input unit. From all parallel bit data T1, the second latch circuit 34b temporarily saves data of only odd bits (usually, 8-bit) and only the data line of the odd bit data is connected to the input unit. Furthermore, an output T4 of the first latch circuit 34a and the second latch circuit 34b is connected to a same output bit line of the first latch circuit 34a and the second latch circuit 34b. In other words, a bit 1 of the output T4 connects an output bit (line) 1 of the first latch circuit 34a and the output bit (line) 1 of the second latch circuit 34b, and a bit 2 of the output T4 connects an output bit (line) 2 of the first latch circuit 34a and the output bit (line) 2 of the second latch circuit 34b. In such a way, each bit line is equivalently connected up to a final bit (usually, 8-bit). The first latch circuit 34a and the second latch circuit 34b maintain data on a rising edge of clock signals that are input in a CLK input and outputs a maintenance status when the signals entered in an output enable (OE) input are High and a high impedance status when the signals entered in an OE input are Low.

The inverter 34c inverts the data transfer clock T2 (T3). In other words, all parallel bits data T1 that is transferred in synchronization with the data transfer clock T2 is maintained in the first latch circuit 34a and the second latch circuit 34b by splitting into the even bits and the odd bits on the rising edge of the data transfer clock T2. The first latch circuit 34a validates the output when the data transfer clock T2 is High and the second latch circuit 34b validates the output when a reversed clock T3 is High. A status of the output T4 is shown in FIG. 5.

The frequency converting circuit 34d converts a frequency of an entered clock into double. In the first and second embodiments, a phased locked loop circuit (PLL) is used. In the frequency converting circuit 34d, the data transfer clock T2 is input and a double frequency clock T5 is output. The status of the clock T5 is shown in FIG. 5.

In a frame memory 36, latch output data T4 is connected as input data and is retrieved in synchronization with the rising edge of the double frequency clock T5. A data output T7 of the frame memory 36 is output in synchronization with a data retrieval clock signal T6 that is delivered from the scanning-image processing unit 11. As a result, a data input T4 and the data output T7 of the frame memory 36 that are shown in FIG. 5 are non-synchronously processed in accordance with a respective required speed.

For reducing the number of signals, each even bit or odd bit for each R, G, B is serially entered by time splitting in the scanning-image processing unit 11 that can handle the color. For using the scanning-image processing unit 11 as common, in the monochromatic scanner, the data format of the monochromatic image data needs to be converted into a color image data format. Thus, the structure mentioned earlier is required. The signal form converter (circuit) 34 that is surrounded by the wavy line is changed to the normal ASIC.

In FIGS. 2 and 3, a discriminating-signal generating circuit 15 that indicates whether an SIU B and B′ are the color SIU B or the monochromatic SIU B′ is connected to the scanning-image processing unit 11 via the connector 3 in the IPU C. The discriminating signals that are generated by the discriminating-signal generating circuit 15 are entered in an input unit (IN2) of the scanning-image processing unit 11. Because the discriminating-signal generating circuit 15 is connected to a GND in the color SIU B and the discriminating-signal generating circuit 15 is pulled up in the monochromatic SIU B′, when the color SIU B is connected to the input unit (IN2) of the scanning-image processing unit 11, Low is entered and when the monochromatic SIU B′ is connected to the input unit (IN2) of the scanning-image processing unit 11, High is entered.

A structure is created in which the exclusive connector H2 physically connects the color SIU B only to the color SBU B and the exclusive connector H2′ connects the monochromatic SIU B′ only to the monochromatic SBU B′, thereby enabling to prevent the wrong combination of the scanners A and A′ and the SIU B and B′.

In FIGS. 2 and 3, a connection detecting signal line 16 that indicates whether the color scanner A and the monochromatic scanner A′ and the color SIU B and the monochromatic SIU B′ are connected with the IPU C is connected to an input unit (IN1) of the scanning-image processing unit 11. The connection detecting signal line 16 is connected to the GND in the color SBU 21 and the monochromatic SBU 31. Further, via the harnesses H and H′ and the exclusive connectors H2 and H2′, and the color SIU B and the monochromatic SIU B′ and via the connector H3, the connection detecting signal line 16 is connected to the IPU C and entered in the input unit (IN1) of the scanning-image processing unit 11.

The connection detecting signal line 16 is pulled up in the IPU C and an active status for the signal is treated as Low. Thus, in the color scanner structure and also in the monochromatic scanner structure, when the color SBU 21 or the monochromatic SBU 31 and the color SIU B or the monochromatic SIU B′ are reliably connected to the IPU C, the status for the connecting detecting signals become active (Low) and when the serially connected units are not connected, the status becomes non-active (High).

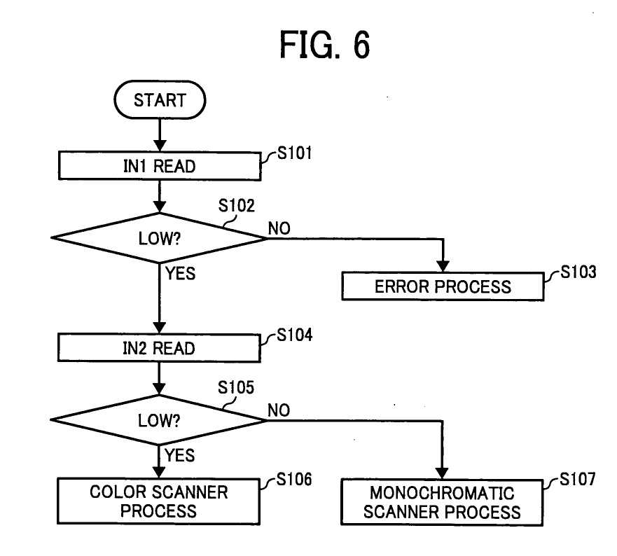

FIG. 6 is a flowchart of a process that determines whether a current connection status indicates the color structure or the monochromatic structure. The scanning-image processing unit 11 within the IPU C determines whether the current connection status indicates the color structure or the monochromatic structure. Because the process proceeds to the corresponding process depending upon a determination result, all the processes are included as software in the scanning-image processing unit 11.

In FIG. 6, the determination process starts after power activation of an apparatus. When the determination process is started, the scanning-image processing unit 11 reads an input status of the input unit (IN1) (step S101). If the input status of the input unit (IN1) is not Low (No at step S102), the scanning-image processing unit 11 determines that the color SBU 21 or the monochromatic SBU 31 or the color SIU B or the monochromatic SIU B′ is not connected and proceeds to an error process (step S103). If the input status of the input unit (IN1) is Low (Yes at step S102), the scanning-image processing unit 11 determines that the color SBU 21 and the color SIU B or the monochromatic SBU 31 and the monochromatic SIU B′ are reliably connected to the IPU C. Next, the scanning-image processing unit 11 reads the input status of the input unit (IN2) (step S104).

Next, the scanning-image processing unit 11 determines the input status of the input unit (IN2) (step S105). Because the color SIU B is connected when the input status of the input unit (IN2) is Low, the scanning-image processing unit 11 determines the structure as the color structure and proceeds to a color scanner process (step S106) and executes a process of the color structure. However, the monochromatic SIU B′ is connected when the input status of the input unit (IN2) is not Low and the scanning-image processing unit 11 determines the structure as the monochromatic structure. Next, the scanning-image processing unit 11 proceeds to a monochromatic scanner process (step S107) and executes the process of the monochromatic structure.

According to the first and second embodiments, by using the common IPU C, making the color SIU B or the monochromatic SIU B′ as exclusive, and by absorbing the interface difference of the color SBU 21 and the monochromatic SBU 31, the monochromatic structure or the color structure can be created. Thus, the new controller software is not required to be developed, thereby enabling to simplify creation operations at the consumption site.

The exclusive color SIU B or the exclusive monochromatic SIU B′ are created as the circuit configuration in which the image processing memory (frame memory) of a minimum capacity required for the SIU B and B′ is installed, thereby enabling to optimize the cost with respect to the machine having the monochromatic structure.

Because the color SBU 21 or the monochromatic SBU 31 are connected to the color SIU B or the monochromatic SIU B′ by the harnesses H1, H1′ via the connector H2 of the color structure and the connector H2′ of the monochromatic structure, the color SIU B or the monochromatic SIU B′ can be flexibly positioned within the plotter 1. Due to this, the creation work at the consumption site can be simplified. Because the color SIU B or the monochromatic SIU B′ are connected to the IPU C by the common board-to-board connector H3 of the color and the monochromatic structure, the frame memory 36, 23, and 33 that prevent deterioration of the image signals can be installed in the color SIU B or the monochromatic SIU B′.

The monochromatic scanner interface is considered as a TTL interface 13a and the color scanner interface is considered as the LVDS interface 21a, thereby enabling to optimize the cost with respect to the characteristics of each image signal.

Because the image transfer format of the monochromatic scanner A′ is to be converted into the image transfer method of the color scanner A in the monochromatic SIU B′, the common IPU C is used and with respect to the characteristics of each image signal of R, G, B, the cost can be optimized.

The discriminating-signal generating circuit 15 is provided in the monochromatic SIU B′ and the color SIU B. Because the IPU C can determine the current structure of the digital multifunction product due to the discriminating signals generated by the discriminating-signal generating circuit 15, not only a hardware but also the software of the IPU C can be used as common.

Because the SBU interface connectors H2′ and H2 that are installed in the monochromatic SIU B′ and the color SIU B are not physically common, the wrong connection can be prevented between the color SBU A or the monochromatic SBU A′ and the color SIU B or the monochromatic SIU B′ and with respect to the discriminating signals of the color SIU B or the monochromatic SIU B′, the color SBU A or the monochromatic SBU A′ can be reliably connected.

The connection detecting signal line 16 is provided that detects whether the monochromatic SBU 31 and the monochromatic SIU B′ and the color SBU 21 and the color SIU B are reliably connected. Because an availability of connection can be checked due to the connection detecting signals, the wrong connection between each unit and the IPU C can be prevented and reliability of SIU discriminating signals can be ensured.

Due to the discriminating signals and the connection detecting signals of the monochromatic SIU B′ and the color SIU B, the connection status can be detected using the software of the IPU C and the structure can be determined. Thus, not only the hardware of the IPU C but also the software can be used as common.

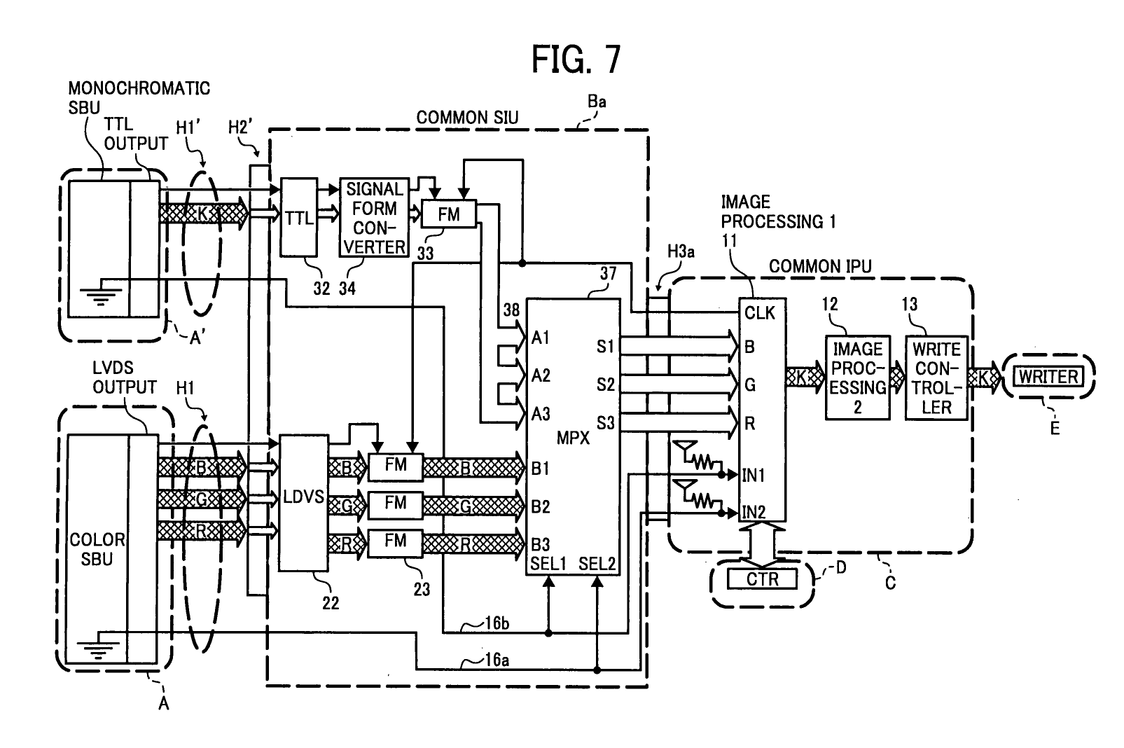

FIG. 7 is a block diagram of a circuit configuration of the digital multifunction product according to a third embodiment of the present invention. In the third embodiment, instead of creating the separate color SIU B and the monochromatic SIU B′ as in the first and second embodiments, a common SIU is created. Basically, the structure includes the combination of the color SIU B and the monochromatic SIU B′. Points that differ from the first and second embodiments are explained next. Same reference symbol/numeral is assigned to each unit resembling the unit explained in the first and second embodiments and a redundant explanation is suitably omitted.

In the third embodiment, the color SIU B that is shown in FIG. 2 and the monochromatic SIU B′ that is shown in FIG. 3 are considered as a common SIU Ba and the color SBU 21 and the monochromatic SBU 31 are connected by a common SIU connector H2a. In the common SIU connector H2a, the connector H2 shown in FIG. 2 and the connector H2′ shown in FIG. 3 are combined and each signal is allocated to a pin inside the common SIU connector H2a. In FIG. 7, for showing that the respective signal cluster of the harnesses H1 and H1′ is allocated to different pins inside the common SIU connector H2a, two respective signal cluster of the harnesses H1 and H1′ are connected simultaneously to the common SIU connector H2a in the drawing. In actual structure, only the harness H1 that sends the signal cluster of a color system or the harness H1′ that sends the signal cluster of a monochromatic system is connected to the common SIU connector H2a.

In FIG. 7, a multiplexer (MPX) 37 is positioned in a subsequent step of the frame memories 23 and 33 in the common SIU Ba. According to the status of the signals that are input in each terminal of a SELL and a SEL2, the multiplexer 37 selects one of the signal clusters from the signal cluster entered in A1, A2, and A3 and the signal cluster entered in B1, B2, and B3 and outputs the selected signal cluster from S1, S2, and S3.

In the third embodiment, when the SEL1 is Low and the SEL2 is High, an A series is selected and when the SEL1 is High and the SEL2 is Low, a B series is selected and a setting is carried out such that the selected series can be output from S1, S2, and S3.

In other words, image signals 38 of the monochromatic SBU system are connected to A1, A2, and A3 input of the multiplexer 37. The image signals 38 correspond to an output of the frame memory 33 that is shown in FIG. 3. Furthermore, image signals 39 of the color SBU system are connected to B1, B2, B3 input of the multiplexer 37. The image signals 39 correspond to the output of the frame memory 33.

Signal 16a is the connection detecting signal of the color SBU A and signal 16b is the connection detecting signal of the monochromatic SBU A′. When the signal cluster of the monochromatic system (harness 1′) is connected to the common SIU connector H2a, the connection detecting signal 16b of the monochromatic SBU A′ is Low and the connection detecting Signal 16a of the color SBU A is High. When the signal cluster of the color system (harness H1) is connected to the common SIU connector H2a, the connection detecting signal 16b of the monochromatic SBU A′ is High and the connection detecting signal 16a of the color SBU A is Low. Because the connection detecting signal 16a and 16b are connected to the respective SELL and the SEL2 of the multiplexer 37, when the signal cluster of the monochromatic system (harness H1′) is connected, the image signals 38 that are connected to A1, A2, and A3 are output from S1, S2, S3 and when the signal cluster of the color system (harness H1) is connected, the image signals 39 that are connected to B1, B2, B3 are output from S1, S2, S3.

The output from S1, S2, S3 is entered in the scanning-image processing unit 11 via a connecter H3a. Further, upon reading the status of the signals of the input units (IN1 and IN2), the scanning-image processing unit 11 can identify whether the current structure is the monochromatic structure or the color structure. The IPU C according to the first embodiment and the IPU C according to the third embodiment are similar. The common SIU Ba according to the third embodiment is changed as the ASIC.

According to the third embodiment, because the SIU B. B′ can be switched to the monochromatic or the color, the SIU B, B′ is considered as common. Due to this, a separate SIU is not required to be created for the plotter 1. If a site where the plotter 1 cannot be created due to circumstances at the consumption site and the site where the plotter 1 can be created are available, at the site where creation is possible, a machine having the structure for creating the SIU according to the first embodiment is handled that is beneficial from the cost point of view and at the site where creation is not possible, the common SIU is already installed in the production site according to the third embodiment and shipped. Due to this, an optimum cost can be saved with respect to a creation site and the plotter 1 can be used as common under the IPU C.

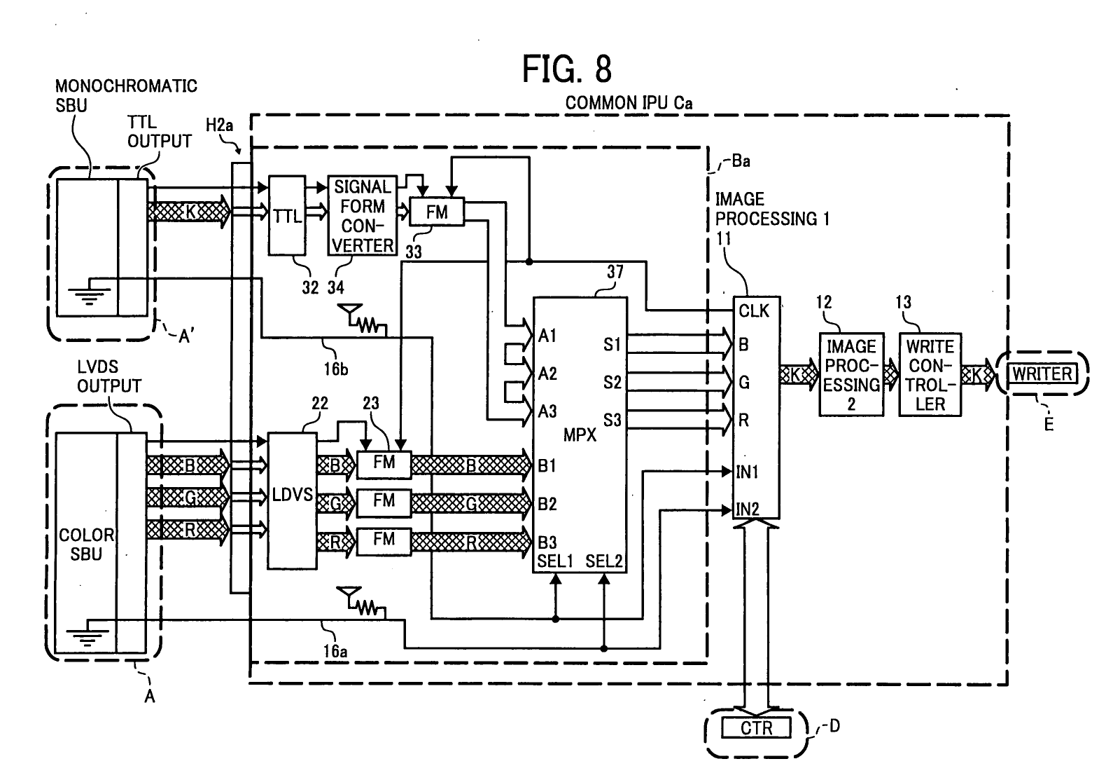

FIG. 8 is a block diagram of the circuit configuration of the digital multifunction product according to a fourth embodiment of the present invention.

In the fourth embodiment, the IPU C and the common SIU Ba according to the third embodiment are combined. The connector H3a according to the third embodiment is omitted and a functional block is consolidated in a common IPU Ca in the structure similar to the third embodiment and the common SIU Ba is not shown as a unit structure. Each unit that is not specifically explained includes the structure and functionality similar to the third embodiment. In FIG. 8, a portion (the common SIU Ba in FIG. 7) within a dashed line A is changed as the ASIC.

According to the fourth embodiment, because switching to the monochrome or the color is possible, the common IPU Ca is used and the main plotter needs not to be created.

Furthermore, if the plotter cannot be created at the consumption site due to the circumstances and if the site where the plotter can be created is not available, the fourth embodiment is beneficial than the third embodiment from the cost point of view.

In embodiments, a monochromatic plotter unit corresponds to a reference numeral 1, a monochromatic scanner corresponds to a reference numeral 3, an image forming apparatus corresponds to a reference numeral 4, a monochrome reader corresponds to a reference numeral 31 (or a reference symbol A′), a color scanner corresponds to a reference numeral 2, an exclusive color reader corresponds to a reference numeral 21 (or a reference symbol A), a common image-processing unit corresponds to a reference numeral 12, a monochrome interface corresponds to a reference symbol B′, a color interface corresponds to a reference symbol B, a monochrome interface circuit corresponds to a reference numeral 32, a color interface circuit corresponds to a reference numeral 22, a storage unit corresponds to a reference numerals 23 and 33, a harness corresponds to reference symbols H1 and H1′, an interface connector corresponds to reference symbols H2 and H2′, a signal form converting unit corresponds to a reference numeral 34, a discriminating signal generating unit corresponds to a reference numeral 15, a connection detecting signal line corresponds to a reference numeral 16, a common interface for a monochrome and a color corresponds to a reference symbol Ba, and an image-processing unit in which the interface is integrally provided corresponds to a reference symbol Ca.

According to an embodiment of the present invention, due to a structure of each unit, a new controller software is not required to be developed, thereby enabling to simplify creation operations at a consumption site.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus that facilitates combination of a monochromatic scanner or a color scanner with a monochromatic plotter comprising:
a common image-processing unit for a monochrome and a color that processes monochromatic image data and color image data that is entered, via an interface, from an exclusive reader for the monochromatic scanner and the exclusive reader for the color scanner, wherein
the image-processing unit processes the monochromatic image data when the monochrome reader is connected, and processes the color image data when the color reader is connected.

2. The image forming apparatus according to claim 1, wherein a monochrome interface is used when connecting the monochrome reader, while a color interface is used when connecting the color reader.

3. The image forming apparatus according to claim 2, further comprising:
an interface circuit for connecting the monochrome reader to a monochrome interface and a storage unit of a capacity necessary for a monochromatic image processing; and
an interface circuit for connecting the color reader to a color interface and the storage unit of the capacity necessary for a color image processing.

4. The image forming apparatus according to claim 2, further comprising:
an exclusive interface connector for the monochrome interface for connecting, via a harness, the monochrome reader to the monochrome interface;
a common interface connector for the monochrome and the color for connecting to the image-processing unit;
an exclusive interface connector for the color interface for connecting, via the harness, the color reader to the color interface; and
the common interface connector for the monochrome and the color for connecting to the image-processing unit.

5. The image forming apparatus according to claim 4, wherein the exclusive interface connector for the monochrome interface and the exclusive interface connector for the color interface are separate interfaces.

6. The image forming apparatus according to claim 2, wherein the monochrome interface is a transistor-transistor level (TTL) interface and the color interface is a low-voltage differential signaling (LVDS) interface.

7. The image forming apparatus according to claim 6, wherein the monochrome interface includes a signal form converter that splits into even bits and odd bits, image data whereof all bits are parallely transferred simultaneously from the monochrome reader, alternately time splits the even bits and the odd bits, and transfers the even bits and the odd bits to the image-processing unit.

8. The image forming apparatus according to claim 2, wherein
the monochrome interface and the color interface include a respective discriminating signal generating unit that generates discriminating signals indicating whether an interface is the monochrome interface or the color interface, and
the image-processing unit discriminates, based on the discriminating signals, that the connected reader is the monochrome reader or the color reader.

9. The image forming apparatus according to claim 8, wherein
the monochrome reader and the color reader include a respective connection detecting signal line that indicates that the monochrome and the color reader are connected, and
the image-processing unit detects, upon the monochrome reader or the color reader connecting the interface, that the monochrome reader or the color reader is connected.

10. The image forming apparatus according to claim 9, wherein the image-processing unit determines, upon reading a status of the discriminating signals and the connection detecting signals, whether a current connection status is a monochromatic structure or a color structure.

11. The image forming apparatus according to claim 1, wherein the interface for the monochrome and the color is common.

12. The image forming apparatus according to claim 11, wherein the interface is integrally provided in the image-processing unit.

13. The image forming apparatus according to claim 11, wherein
the monochrome reader and the color reader include the respective connection detecting signal line that indicates that the monochrome reader and the color reader are connected, and
the image-processing unit determines, upon the monochrome reader or the color reader connecting to the interface, based on the connection detecting signals, that the monochrome reader or the color reader is connected, and switchovers, depending upon a determination result, the interface to the monochrome or the color.
